(19) United States
(12) Patent Application Publication
(10) Pub. No.: US 2013/0084374 A1
(43) Pub. Date: Apr. 4, 2013

(54) BAG, PARTICULARLY RE-BAKING BAG, MADE OF GLASSINE PAPER OR CELLULOSE PAPER WITH A FLUORINE COATING

(71) Applicant: Papier-Mettler. Inhaber Michael Mettler e.K., Morbach (DE)

(72) Inventor: Christian Budday, Trier (DE)

(73) Assignee: PAPIER-METTLER, INHABER MICHAEL METTLER E.K., Morbach (DE)

(21) Appl. No.: 13/631,805

(22) Filed: Sep. 28, 2012

(30) Foreign Application Priority Data
Sep. 30, 2011 (EP) 11 007 991.0

(51) Int. Cl. B65D 81/34; B32B 1/02

(52) U.S. Cl. 426/394; 428/34.3

(57) ABSTRACT

A bag containing foods, particularly foods to be re-heated or cooked and/or bakery products which are pre-baked and/or need to be re-baked, with an essentially closed bottom end and an opposing opening end, comprises a front wall and a rear wall that are attached to each other, at least in one or more sections, directly or through side walls, in the region of their side edges and bottom edges. The front wall and/or the rear wall and optionally also at least one side wall, preferably all side walls, comprise or are made of glassine paper and/or cellulose paper with a single- or double-sided fluorine coating.

### FIELD

The present invention relates to a bag for containing foods, particularly foods which need to be re-heated or cooked and/or bakery products which are pre-baked and/or need to be re-baked.

### BACKGROUND

For hygienic and other reasons, bakery products are regularly packaged before being presented to the customer. This applies also to products that are re-heated or re-baked at the point of sale. To facilitate handling and minimize transport, repackaging, and processing steps, food products to be re-heated or re-baked are frequently delivered in the actual retail packaging and re-heated or re-baked at the point of sale shortly before actually being consumed. Another consideration with regard to bakery products to be finally baked or re-baked immediately before they are sold is that, as a rule, they are inserted into the retail packaging after pre-baking, that is, when they are still warm, and stored deep-frozen in said retail packaging at a temperature of about −20° Celsius. It is only shortly before the final baking that the pre-baked bakery product is thawed out in the retail packaging and exposed to baking temperatures between 180° C. and 200° C. The foods to be heated or re-baked regularly emit oils and fats when heated or re-baked. For traditional re-baking bags, this frequently has the effect that the bags can be used for further handling either only to a limited extent or not at all, for example, because they are greasy and their appearance is no longer perfect. In addition, when traditional re-baking bags are used, this does not reduce the substantial cleaning effort required for the cooking appliances that are employed. During the cleaning phases, the re-baking and cooking appliances cannot be used for their intended purpose. Also, personnel must be made available to do the cleaning. This can entail unnecessary revenue losses.

### SUMMARY AND INITIAL DESCRIPTION

Disclosed herein are various embodiments of a bag usable for containing foods, particularly foods that need to be re-heated or cooked and/or bakery products that are pre-baked and/or need to be re-baked. In at least one embodiment, the bag has a closed bottom end and an opposing opening end. The bag further has a front wall and a rear wall which are attached to each other, at least in sections, directly or through side walls, in the region of their side edges and bottom edges. The present disclosure further relates to the utilization of said bags as re-baking bags or heating bags for bakery products or foods. Generally, the bags described herein can be made adequately and lastingly resistant to grease even at higher temperatures, and at the same time unobjectionable from the point of view of food safety regulations.

In various embodiments, disclosed herein are bags, particularly re-baking bags, that do not have the disadvantages of bags known from prior art and with which foodstuff can be stored, in particular over an extended period as well as over a wide range of temperatures, without losing its freshness and consistency, and which even after a re-heating or re-baking process retain an appearance pleasing to the eye and can be used as a consumption container. In at least some embodiments, good air circulation between the inside and the outside of the bag is provided.

Accordingly, a bag for containing foods, particularly foods to be re-heated or cooked and/or bakery products which are pre-baked and/or need to be re-baked, with an essentially closed bottom end and an opposing opening end, has been invented. In at least one embodiment, the bag comprises a front wall and a rear wall that are attached to each other, at least in sections, directly or through side walls, in the region of their side edges and bottom edges, wherein the front wall and/or the rear wall and optionally also at least one side wall, preferably all side walls, comprise or are made of glassine paper and/or cellulose paper with a single- or double-sided fluorine coating.

Glassine papers and their manufacture are known in the art. The manufacturing of glassine papers is described, for example, in the “Encyclopedia of Polymer Science and Technology” (Volume 9, John Wiley, 1968, page 719). Suitable glassine papers are commercially available in bleached or unbleached form. Glassine paper is usually made of fine-grained cellulose. Suitable glassine paper can be produced, for example, by repeated moistening and calendering of sulfite cellulose. In at least one embodiment, glassine paper used in the bags disclosed herein can be made completely or almost completely of virgin fibers. Its high transparency is achieved by a process called super-calendering, i.e., by pronounced smoothing and pressing of papers. Suitable glassine papers are preferably smoothed on both sides. The calendering regularly takes place in a calender by a rolling process. Compared to imitation greaseproof paper, glassine paper has less wet strength. Such glassine papers that are approved as food contact materials in compliance with Regulation (EC) No. 1935/2004 are readily available on the market. Such glassine papers are preferred, as are glassine papers that comply with food safety regulations according to BFR 36/2.

Generally, the grammage of particularly suitable glassine papers ranges from 20 to 150 g/m², preferably from 30 to 90 g/m², and particularly preferably from 35 to 65 g/m², determined according to ISO 536. The thickness of particularly suitable glassine papers ranges from 20 to 100 μm, particularly from 30 to 80 μm. The density of particularly suitable glassine papers ranges from 0.8 to 2.0 g/cm³, preferably from 1.0 to 1.5 g/cm³, determined according to ISO 534. The air permeance of particularly suitable glassine papers according to the Bendtsen method (determined according to DIN EN 53120 T1-08.79) ranges from 5 to 30 ml/min, particularly from 6 to 25 ml/min. The residual moisture of suitable glassine papers, determined according to ISO 287, preferably ranges from 4% to 12%, preferably from 5% to 10%, for example from 6% to 8% or from 7% to 9%. Furthermore, the grease resistance OS and/or the grease resistance SS of suitable glassine papers, both determined according to TAPPI T-454-05.96, are preferably higher than 1,400 sec, particularly higher than 1,600 sec, and especially preferably higher than 1,800 sec. The preceding features can be realized individually, in any combination, or fully in the glassine papers used according to the present disclosure.

The glassine paper can be single- or multi-layer glassine paper. Methods for laminating two or more layers of glassine paper on top of each other are known in the art. Accordingly, it is of course possible to use glassine papers consisting of several layers of glassine paper for the bags of the present disclosure.

The glassine paper utilized for the bags of the present disclosure is preferably suitable for embossing and/or printing, particularly for embossing and/or printing on both sides.

Furthermore, such glassine papers preferably have not been surface treated, particularly with silicone substances or fluorinated substances.

Papers made of cellulose or papers essentially completely based on cellulose are known in the art as well. This also applies to cellulose papers with a single- or double-sided fluorine coating. For example, if no particular value is attached to the printing or the print quality of the bag, it is possible to use cellulose paper with a single-sided coating.

If a cellulose paper with a single-sided fluorine coating is used for a bag of the present disclosure, the fluorine-coated side of the paper preferably faces the interior of the bag or forms the interior side of the bag. This is regularly the side facing or contacting the food product to be re-heated, re-baked, or cooked.

The grammage of particularly suitable cellulose papers with a fluorine coating ranges from 20 to 150 g/m², preferably from 25 to 140 g/m², and particularly preferably from 30 to 110 g/m², for example from 32 to 100 g/m², determined according to ISO 536.

In principle, all cellulose papers which have been treated with a compound containing fluorine can be used as suitable cellulose papers with fluorine coating. These can be, e.g., partially fluorinated or perfluorinated compounds, for example, monomeric and polymeric compounds. Particularly preferably, such cellulose papers with a single- or double-sided fluorine coating are used which are essentially free of fluorosurfactants, particularly essentially free of fluorotelomer alcohol (FTOH), perfluorooctane sulfonates (PFOS), and/or perfluorooctanoic acid or its salts.

Suitable cellulose papers may have been treated with at least one partially fluorinated or perfluorinated polymer and/or a compound with at least one partially fluorinated and/or perfluorinated linear or branched carbon chain, for example, with 2 to 50 carbon atoms. Suitable partially fluorinated or perfluorinated compounds include:
ammonium di-[2-(N-ethyl-hepta-decafluorosulfonamido)ethyl] phosphate,
poly(2-(N-methyl-heptadecafluorosulfonamido)-ethyl acrylate)-co-(2,3-epoxypropylacrylate)-co-(2-ethoxyethylacrylate)-co-(2-(2-methylpropenyloyloxy)ethyl trimethylammonium-chloride, and
poly(2-(N-methyl-heptadecafluoro-sulfonamido)ethyl acrylate)-co-(2,3-epoxypropyl acrylate)-co-(2-ethoxyethyl acrylate)-co-(2-(2-methylpropenyloyloxy)ethyl-trimethylammonium-chloride.

Such compounds are commercially available, for example, under the trade names Scotchban FX 845 (3M) and Foraperle 321 (Atochem).

In at least one embodiment of a bag according to the present disclosure, the front wall and/or the rear wall and also optionally at least one side wall, preferably all side walls, essentially consist of glassine paper and/or cellulose paper with a single- or double-sided fluorine coating.

Particularly preferably, all paper components of the front wall and/or the rear wall and also optionally at least one side wall, particularly all side walls, essentially consist of glassine paper, particularly all paper components of the front wall and the rear wall and also optionally at least one side wall, particularly all side walls.

In a further embodiment, it is preferred that all paper components of the front wall and/or the rear wall and also optionally at least one side wall, particularly all side walls, essentially consist of cellulose paper with a single- or double-sided fluorine coating, particularly all paper components of the front wall and the rear wall and also optionally at least one side wall, particularly all side walls.

In a variation of the bag disclosed herein, it is possible that the front wall and/or the rear wall and also optionally at least one side wall, preferably all side walls, have perforations, at least in sections.

In this case, the ratio of open surface formed by the perforations to the whole surface of the front wall ranges from 1/25 to 1/500, particularly from 1/50 to 1/250, and/or the ratio of open surface formed by the perforations in the rear wall to the whole surface of the rear wall ranges from 1/25 to 1/500, particularly from 1/50 to 1/250, and/or the ratio of open surface formed by the perforations in at least one side wall to the whole surface of said side wall ranges from 1/25 to 1/500, particularly from 1/50 to 1/250.

The perforation holes preferably have a mean diameter of between 0.2 and 2.0 mm, particularly preferably between 0.4 and 1.5 mm. In a preferred embodiment utilizing glassine paper or cellulose paper with a single- or double-sided fluorine coating, the perforation holes are spaced apart from the immediately adjacent perforation holes at a distance of between about 0.5 and 2.0 cm.

According to a further aspect of the present disclosure, the bags disclosed herein have a rear wall that is formed or made, at least in sections, particularly essentially completely, of glassine paper, and a front wall that is formed or made in at least one first area of glassine paper and formed in at least one second area of a transparent or translucent plastic film, or the front wall is formed of the transparent or translucent second plastic film, wherein the glassine paper and the plastic film are attached to each other with an adhesive, at least in sections, in the region of overlapping contact surfaces. Here the glassine paper and/or the plastic film can also be perforated in accordance with an embodiment of the disclosure.

Furthermore, such bags are also particularly suitable in which the rear wall is formed or made, at least in sections, particularly essentially completely, of cellulose paper with a single- or double-sided fluorine coating, and in which the front wall is formed or made in at least one first area of cellulose paper with a single- or double-sided fluorine coating and formed in at least one second area of a transparent or translucent plastic film, or in which the front wall is formed of the transparent or translucent second plastic film, wherein the cellulose paper with a single- or double-sided fluorine coating and the plastic film are attached to each other with an adhesive, at least in sections, in the region of overlapping contact surfaces.

As adhesives for the bottom end of the bag of the invention, it is possible to use, e.g., dispersion adhesives, particularly polyacrylate-based adhesives. Said adhesives are preferably free of softeners.

Gluing paper to plastic film can be accomplished, for example, by using a preferably aliphatic polyurethane hot melt adhesive, e.g., a one-component moisture-curing reactive polyurethane hot melt adhesive.

It is useful if the plastic film is a polyester film, particularly a PET film, or a polypropylene film, manufactured preferably as a single- or multi-layer film in monoaxially or biaxially oriented form. Particularly preferably plastic films, especially PET films, with little or no shrinkage are utilized.

According to a further aspect of the present disclosure, it is preferred that the air permeance of the glassine paper according to the Bendtsen method (determined according to DIN EN 53120 T1-08.79) ranges from 5 to 30 ml/min, particularly from 6 to 25 ml/min, and the glassine paper is a glassine paper that has not been surface treated and the cellulose paper is based essentially completely on cellulose.

Accordingly, such a preferred embodiment of a bag can provide adequate and lasting resistance to grease, even at higher temperatures, and at the same time is unobjectionable from the point of view of food safety regulations. Moreover, food can be stored in such a bag in particular over an extended period as well as over a wide range of temperatures without losing its freshness and consistency, and which even after the re-heating or re-baking process, retains an appearance pleasing to the eye and could be used as a consumption container. Another advantage of a bag according to this preferred embodiment is that good air circulation between the inside and the outside of the bag can be provided. Thereby, the air circulation is independent of the air pressure difference between the inside and the outside of the bag.

The bags of the present disclosure are suitable as re-baking bags for re-baking bakery products which are pre-baked and/or need to be re-baked, and as re-heating or cooking bags for foods to be re-heated or cooked, such as pizzas, crêpes, pancakes, burgers, and potato pancakes.

The bags disclosed herein are based on a surprising finding that a grease- and heat-resistant packaging suitable for foods and also complying with all food safety regulations can be achieved if the packaging is made essentially completely of glassine paper and/or cellulose paper with a single- or double-sided fluorine coating. These papers are color-fast even after submission to a re-heating or cooking process. In particular, said papers and the bags made using said papers still have sufficient mechanical stability and bursting strength after such a re-baking, re-heating, or cooking process.

### DESCRIPTION OF THE DRAWINGS

In the following description, the present disclosure is explained in more detail by means of a preferred embodiment relating to the enclosed drawings, wherein:

FIG. 1 is a schematic perspective view of an embodiment of a bag according to the present disclosure; and

FIG. 2 is a schematic perspective view of a further embodiment of a bag according to the present disclosure.

### DETAILED DESCRIPTION

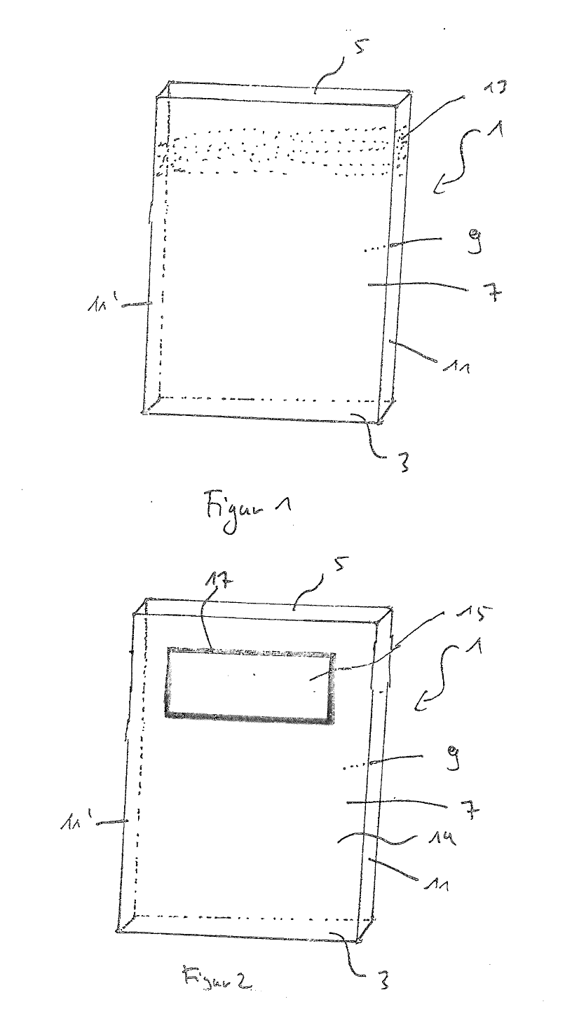

FIG. 1 shows a bag (1) for containing foods with an essentially closed bottom end (3) and an opposing opening end (5), comprising a front wall (7) and a rear wall (9) which are attached to each other through side walls (11, 11′) in the region of their side edges and bottom edges. The front wall (7) and the rear wall (9) and optionally also the side walls (11, 11′) comprise or are made of glassine paper and/or cellulose paper with a single- or double-sided fluorine coating.

Furthermore, in the illustrated embodiment, the front wall (7) and the back wall (9) and the side walls (11, 11′) have perforations (13).

FIG. 2 shows an alternative embodiment of a bag as shown in FIG. 1. A bag according to this embodiment can also have perforations at the front wall (7), the back wall (9), and/or the side walls (11, 11′), even if such perforations are not shown in FIG. 2.

According to the embodiment shown in FIG. 2, the rear wall (9) is formed of glassine paper, and the front wall is formed in at least one first area (14) of glassine paper and in the second area (15) of a transparent or translucent plastic film, wherein said first and second areas (14, 15) are attached to each other with an adhesive in the region (17) of overlapping contact surfaces.

The features of the present invention disclosed in the description above, in the claims, and in the drawings can be important for implementing the invention in its different embodiments both individually and in every possible combination thereof.

The embodiments of the invention in which an exclusive property or privilege is claimed are defined as follows:

1. A bag for containing foods, comprising:
a closed bottom end;
an opposing opening end; and
a front wall and a rear wall that are attached to each other, at least in one or more sections, directly or through side walls, in the region of their side edges and bottom edges,
wherein the front wall and/or the rear wall comprise or are made of glassine paper and/or cellulose paper with a single- or double-sided fluorine coating.

2. The bag of claim 1, wherein the front wall and/or the rear wall essentially consist of glassine paper and/or cellulose paper with a single- or double-sided fluorine coating.

3. The bag of claim 1, wherein the front wall and/or the rear wall have perforations, at least in one or more sections.

4. The bag of claim 3, wherein the ratio of open surface formed by the perforations to the whole surface of the front wall ranges from 1/25 to 1/500, and/or the ratio of open surface formed by the perforations in the rear wall to the whole surface of the rear wall ranges from 1/25 to 1/500.

5. The bag according to claim 1, wherein the bag is configured for re-baking bakery products that are pre-baked and/or need to be re-baked, or for re-heating or cooking foods to be re-heated or cooked.

6. The bag according to claim 1, wherein the density of the glassine paper ranges from 0.8 to 2.0 g/cm³.

7. The bag according to claim 1, wherein the cellulose paper is based essentially completely on cellulose.

8. The bag according to claim 1, wherein the grammage of the glassine paper ranges from 20 to 150 g/m², and/or the thickness of the glassine paper ranges from 20 to 100 μm.

9. The bag according to claim 1, wherein the rear wall is formed, at least in one or more sections, of glassine paper, and wherein the front wall is formed in at least one first area of glassine paper and in at least one second area of a transparent or translucent plastic film.

10. The bag of claim 1, wherein the rear wall is formed, at least in one or more sections, of cellulose paper with a single- or double-sided fluorine coating, and wherein the front wall is formed in at least one first area of cellulose paper with a single- or double-sided fluorine coating and in at least one second area of a transparent or translucent plastic film.

11. The bag of claim 9, wherein the glassine paper is perforated.

12. The bag of claim 9, wherein the plastic film is a polypropylene film or a polyester film manufactured as a single- or multi-layer film in monoaxially or biaxially oriented form.

13. The bag according to claim 1, wherein the glassine paper is a single- or multi-layer glassine paper, or wherein the cellulose paper with a single- or double-sided fluorine coating is a single- or multi-layer cellulose paper.

14. The bag according to claim 1, wherein the glassine paper is a glassine paper that has not been surface treated, and/or wherein the cellulose paper with a single- or double-sided fluorine coating is essentially free of fluorosurfactants.

15. The bag according to claim 1, wherein:
the air permeance of the glassine paper according to the Bendtsen method (determined according to DIN EN 53120 T1-08.79) ranges from 5 to 30 ml/min;
the glassine paper is a glassine paper that has not been surface treated; and
the cellulose paper is based essentially completely on cellulose.

16. The bag according to claim 1, wherein at least one side wall comprises or is made of glassine paper and/or cellulose paper with a single- or double-sided fluorine coating.

17. The bag according to claim 1, wherein at least one side wall has perforations, at least in one or more sections.

18. The bag according to claim 1, wherein the rear wall is formed, at least in one or more sections, of glassine paper, and wherein the front wall is formed of a transparent or translucent plastic film, wherein the glassine paper and the plastic film are attached to each other with an adhesive, at least in one or more sections, in the region of overlapping contact surfaces.

19. The bag according to claim 1, wherein the rear wall is formed, at least in one or more sections, of cellulose paper with a single- or double-sided fluorine coating, and wherein the front wall is formed of a transparent or translucent plastic film, wherein the cellulose paper with a single- or double-sided fluorine coating and the plastic film are attached to each other with an adhesive, at least in one or more sections, in the region of overlapping contact surfaces.

20. The bag of claim 9, wherein the plastic film is perforated.

21. The bag of claim 9, wherein the plastic film is a polypropylene film or a polyester film manufactured as a single- or multi-layer film in monoaxially or biaxially oriented form.

22. The bag of claim 10, wherein the cellulose paper with a single- or double-sided fluorine coating is perforated.

23. The bag of claim 10, wherein the plastic film is perforated.

24. The bag of claim 10, wherein the plastic film is a polypropylene film or a polyester film manufactured as a single- or multi-layer film in monoaxially or biaxially oriented form.

25. A method of using a bag containing food, comprising:
obtaining a bag containing food, wherein the bag comprises a closed bottom end, an opposing opening end, a front wall, and a rear wall, wherein the front wall and rear wall are attached to each other, at least in sections, directly or through side walls, in the region of their side edges and bottom edges, and wherein the front wall and/or the rear wall comprise or are made of glassine paper and/or cellulose paper with a single- or double-sided fluorine coating; and
baking, re-baking, cooking, or re-heating the bag containing food.
